(19) United States
(12) Patent Application Publication
(10) Pub. No.: US 2023/0229059 A1
(43) Pub. Date: Jul. 20, 2023

(54) AUTOFOCUS DEVICE BASED ON MOVABLE SENSOR DRIVEN BY SMA WIRE

(71) Applicant: AAC Optics (Suzhou) Co., Ltd., Suzhou (CN)

(72) Inventor: Jarno Matikainen, Tampere (FI)

(21) Appl. No.: 17/575,656

(22) Filed: Jan. 14, 2022

(51) Int. Cl. G03B 13/36; H04N 5/225; H04N 5/232

(52) U.S. Cl. CPC G03B 13/36; H04N 5/232; H04N 5/2252; H04N 5/2254

(57) ABSTRACT

An autofocus device based on a movable sensor driven by an SMA wire is provided. The autofocus device includes a housing including a first and second mounting grooves communicating with each other; a lens fixed inside the first mounting groove; a sensor assembly provided inside the second mounting groove and being reciprocally movable along a direction of an optical axis of the lens; and a driving element including the SMA wire having two end portions fixed on the housing and a middle portion connected to the sensor assembly, the middle portion is further away from the lens than the end portions, and configured to drive the sensor assembly to move under thermal shrinking; and an elastic element connected to the sensor assembly and configured to provide the sensor assembly with a restoring force so that the sensor assembly returns to an initial position.

### TECHNICAL FIELD

The present disclosure relates to the technical field of cameras, and in particular, to an autofocus device based on a movable sensor driven by an SMA wire.

### BACKGROUND

With the development of portable electronic devices such as mobile phones or tablet computers, the requirements for accompanying camera functions have been relatively increased.

The existing camera includes a camera lens module and a driving device. The camera lens module is disposed inside a predetermined mounting member and is located on an optical axis, and is movable toward an approaching object in a sliding or spirally rotatable manner. The driving device is configured to drive the camera lens to move along the optical axis. The existing camera is driven mainly by a magnet and coil structure, which makes the mechanism and the movement manner for the movement of the camera lens module too complicated, is difficult to have a reduced size, and is unable to meet the requirements for product miniaturization.

### SUMMARY

The present disclosure provides an autofocus device based on a movable sensor driven by an SMA wire. The autofocus device includes a housing, a lens, a sensor assembly, a driving element, and an elastic element. The housing includes a first mounting groove and a second mounting groove communicating with the first mounting groove. The lens is fixed inside the first mounting groove. The sensor assembly is provided inside the second mounting groove and reciprocally movable along a direction of an optical axis of the lens. The driving element includes the SMA wire having two end portions fixed on the housing and a middle portion connected to the sensor assembly, the middle portion is further away from the lens than the two end portions, and the SMA wire is configured to drive the sensor assembly to move towards the lens under an actuation force generated by thermal shrinking of the SMA wire. The elastic element is connected to the sensor assembly and configured to provide the sensor assembly with a restoring force in a direction away from the lens when the SMA wire is cooled to expand and return to an initial length, so that the sensor assembly returns to an initial position.

As an improvement, the driving element further includes a protrusion that has an end fixed to a side of the sensor assembly facing away from the lens and another end recessed to form an actuation groove. A groove surface of the actuation groove includes a first position end and second position ends, and the first position end is farther from the sensor assembly than each of the second position ends. The SMA wire is bridged in the actuation groove and attached to the groove surface of the actuation groove.

As an improvement, the first position end is located at a middle of the groove surface of the actuation groove, and the second position ends are located at two opposite sides of the groove surface of the actuation groove.

As an improvement, the first position end is located on an extension line of the optical axis of the lens.

As an improvement, the SMA wire has two opposite ends and a middle movable end located between the two opposite ends, the two opposite ends of the SMA wire are fixed to the housing, and the middle movable end of the SMA wire is tightly suspended in the actuation groove.

As an improvement, the two opposite ends of the SMA wire are fixed by clamping, bonding, or welding.

As an improvement, the autofocus device further includes a metal element provided on the housing at a position close to an opening of the second mounting groove, and configured to fix the two end positions of the SMA wire.

As an improvement, the elastic element includes at least one elastic sheet provided between the sensor assembly and a bottom surface of the second mounting groove. Each of the at least one elastic sheet includes an elastic portion and a fixed portion, the fixed portion is provided at an end of the sensor assembly extending into the second mounting groove, and the elastic portion is connected to the fixed portion and extends in a direction away from the sensor assembly.

As an improvement, the elastic element includes at least two elastic sheets that are symmetrically arranged.

As an improvement, the lens is fixed inside the first mounting groove by a screw connection.

### BRIEF DESCRIPTION OF DRAWINGS

FIG. 1 is a first perspective view of an autofocus device according to an embodiment of the present disclosure;

FIG. 2 is a second perspective view of the autofocus device according to the embodiment of the present disclosure;

FIG. 3 is a top view of the autofocus device according to the embodiment of the present disclosure;

FIG. 4 is a cross-sectional view of the autofocus device along A-A shown in FIG. 3;

FIG. 5 is a cross-sectional view of the autofocus device along B-B shown in FIG. 3;

FIG. 6 is a bottom view of the autofocus device according to the embodiment of the present disclosure;

FIG. 7 is a perspective view of the autofocus device in a state of a hidden housing according to the present disclosure;

FIG. 8 is a front view of an elastic element of the autofocus device;

FIG. 9 is a front view of a SMA wire of the autofocus device;

FIG. 10 is a perspective view of a protrusion of the autofocus device;

FIG. 11 is a side view of the protrusion shown in FIG. 10; and

FIG. 12 is a cross-sectional view of the protrusion along C-C shown in FIG. 11.

Description of reference signs:
10-housing, 11-first mounting groove, 12-second mounting groove;
20-lens;
30-sensor assembly;
40-SMA wire, 401-opposite ends, 402-middle movable end;
50-protrusion, 51-actuation groove, 511-first position end, 512-second position end;
60-elastic sheet, 601-elastic portion, 602-fixed portion;
70-metal element.

### DESCRIPTION OF EMBODIMENTS

The embodiments of the present invention will be described in details hereinafter. Examples of the embodiments are shown in the accompanying drawings, in which the same or similar reference signs indicate the same or similar elements or elements with the same or similar functions. The embodiments described in the following with reference to the drawings are exemplary and merely used for explaining the present disclosure, and are not intended to limit the present disclosure thereto.

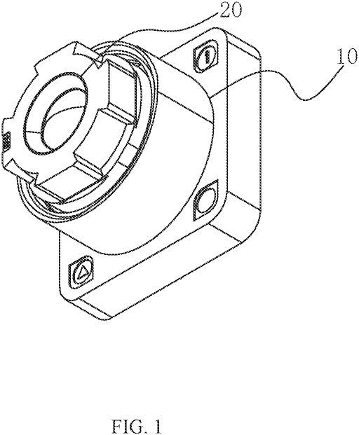

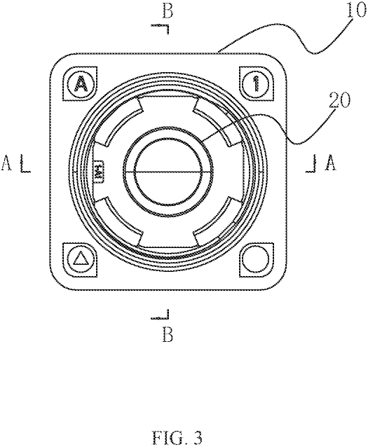

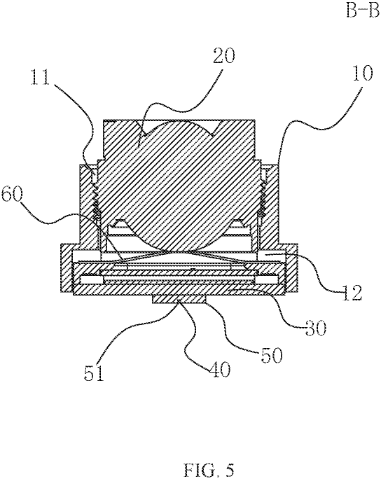

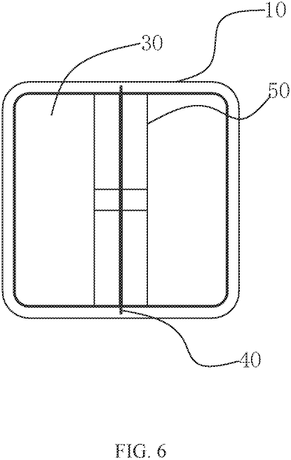

As shown in FIGS. 1 to 6, some embodiments of the present disclosure provide an autofocus device based on a movable sensor driven by an SMA wire. The autofocus device includes a housing 10, a lens 20, a sensor assembly 30, and a driving element.

The housing 10 is configured to accommodate the lens 20 and the sensor assembly 30, and a first mounting groove 11 and a second mounting groove 12 communicating with each other are provided inside the housing 10. Each of the first mounting groove 11 and the second mounting groove 12 forms openings at two opposite ends of the housing 10, and the lens 20 and the sensor assembly 30 are mounted in the housing 10 through the respective openings.

The lens 20 is fixed in the first mounting groove 11, and an inner contour surface of the first mounting groove 11 matches an outer contour surface of the lens 20. In some embodiments, the lens 20 is a cylindrical structure and thus the first mounting groove 11 is a cylindrical groove. In this embodiment, the lens 20 is fixed in the first mounting groove 11, and is unable to move during a focus process. In some embodiments, the lens 20 is fixed in the first mounting groove 11 in a threaded manner. The outer contour surface of the lens 20 is formed with an external thread, and the inner contour surface of the first mounting groove 11 is formed with an internal thread matching the external thread, so that the lens 20 can be screwed into the first mounting groove 11. When the lens 20 is required to be detached, the lens 20 is merely required to be rotated in a reverse direction, thereby conveniently and quickly disassembling the lens.

The sensor assembly 30 is disposed inside the second mounting groove 12 and is reciprocally movable along a direction of an optical axis of the lens 20. An inner contour surface of the second mounting groove 12 matches an outer contour surface of the sensor assembly 30. In this embodiment, the sensor assembly 30 is a cubic structure and thus the second mounting groove 12 is a cubic groove. In this embodiment, the sensor assembly 30 is disposed in the second mounting groove 12 and is slidable along the direction of the optical axis of the lens 20. The second mounting groove 12 may be provided with a guiding and limiting device therein, which is conventional means of sliding pairs and will not be further described herein.

The driving element includes a SMA wire 40 and an actuation mechanism. The number of the SMA wire may be one or more, as long as the driving function can be achieved, which is not limited herein. The SMA wire 40, such as nickel-titanium memory alloy wire, is a martensite structure at room temperature. When the temperature is raised, the SMA wire 40 will undergo a phase change transforming from a martensite structure to an austenite structure, and the SMA wire will decrease both in length and electrical resistance. When the temperature is decreased, the SMA wire 40 will undergo a phase change transforming from an austenite structure to a martensite structure, and the wire will increase both in length and electrical resistance. The two processes may be repeated. During the phase change, linearity between the temperature and strain of the SMA wire 40 is poor, but the resistance and strain of the SMA wire 40 have a linear relationship within a certain temperature range. Therefore, the length of the SMA wire 40 can be accurately controlled by controlling the electrical resistance of the SMA wire 40, and a position and a movement distance of the driving element is calculated based on the electrical resistance of the SMA wire 40.

An end of the actuation mechanism is connected to the sensor assembly 30, and another end of the actuation mechanism is connected to the SMA wire 40. The actuation mechanism may be integrally formed with the sensor assembly 30 into one piece or separately formed as individual structures, which is not limited herein. The actuation mechanism is provided with a convex surface facing away from the sensor assembly 30, and the SMA wire 40 is tightly attached to the convex surface, such that the SMA wire 40 is bent toward a side facing away from the sensor assembly 30. The SMA wire 40 is heated by a control system to shrink due to the heat, and thus the length of the SMA wire 40 becomes smaller. As a result, the bent shape of the SMA wire is straightened to generate an actuation force that is transferred to the sensor assembly 30 through the actuation mechanism, such that the sensor assembly 30 moves toward the lens 20, thereby achieving autofocusing. When the SMA wire 40 is powered off, the temperature of the SMA wire 40 is decreased and the length thereof becomes larger, and the sensor assembly 30 returns to its initial position.

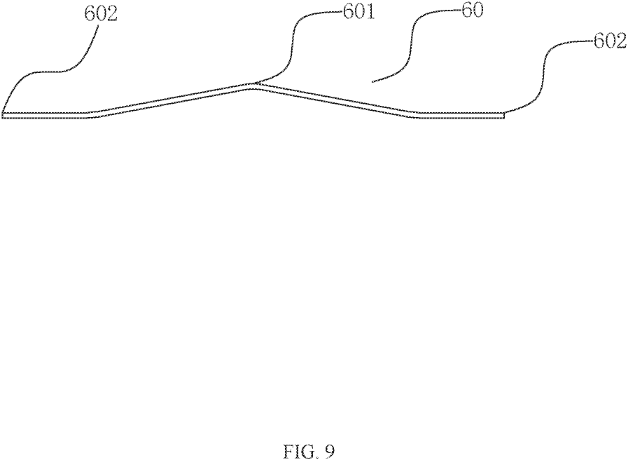

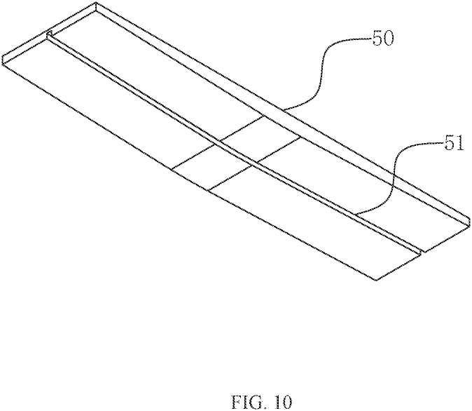

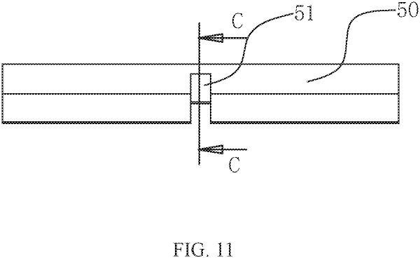

As shown in FIGS. 9 to 12, the actuation mechanism includes a protrusion 50. The protrusion 50 has an end fixed to a side of the sensor assembly 30 facing away from the lens 20 in a fixing manner, such as clamping, bonding, and welding. The protrusion 50 has another end recessed to form an actuation groove 51, a groove surface of which includes a first position end 511 and second position ends 512. The first position end 511 is farther away from the sensor assembly 30 than the second position ends 512, to form at least one slope structure extending toward the side away from the sensor assembly 30. The SMA wire 40 is bridged inside the actuation groove 51 and attached to the groove surface of the actuation groove 51. The SMA wire 40 is naturally or slightly tightly bridged inside the actuation groove 51 in an initial state. Since the groove surface of the actuation groove 51 is a slope surface, the SMA wire 40 is in a bent state. When the SMA wire 40 is heated to shrink, the SMA wire 40 is straightened to exert a force on the protrusion 50 such that the sensor assembly 30 moves toward the lens 20. A telescopic length of the lens 20 can be accurately controlled by controlling the electrical resistance of the SMA wire 40, thereby controlling the movement distance of the sensor assembly 30 and achieving accurate autofocusing.

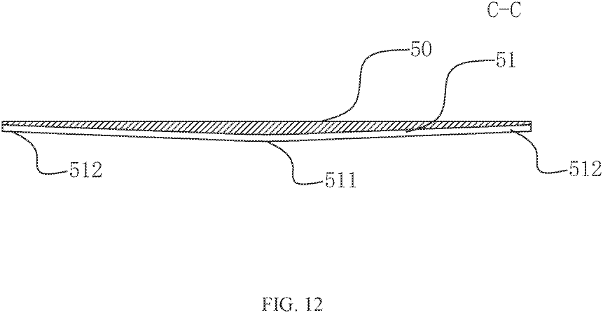

Further, as shown in FIG. 12, the first position end 511 is located at the middle of the groove surface of the actuation groove 51, and the second position ends 512 are located at opposite sides of the groove surface of the actuation groove 51, such that the groove surface of the actuation groove 51 is formed as a V-shaped structure opening toward the lens 20. An opening angle of the V-shaped structure may be adjusted based on the strain characteristics of the SMA wire 40 and a required focus distance. In this embodiment, the opening angle of the V-shaped structure is configured as an obtuse angle to improve movement stability of the sensor assembly 30 and the focus accuracy.

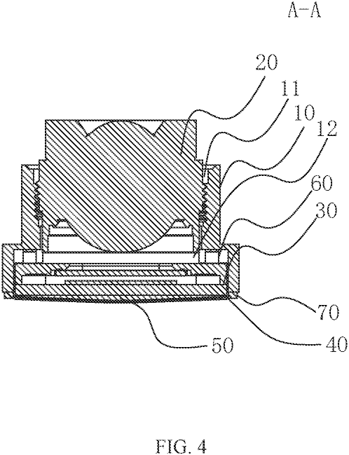

Furthermore, as shown in FIG. 4, the first position end 511 is located on an extension line of the optical axis of the lens 20 such that the driving force of the protrusion 50 is applied on the optical axis of the lens 20. The sensor assembly 30 keeps moving along the direction of the optical axis of the lens 20 during the process of driving the sensor assembly 30 to move, so that the stability and the focus accuracy is further improved.

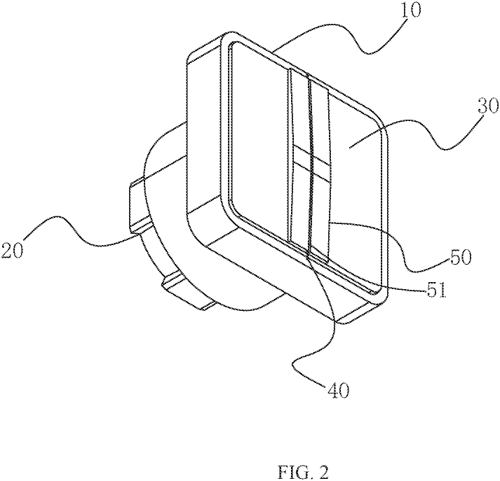

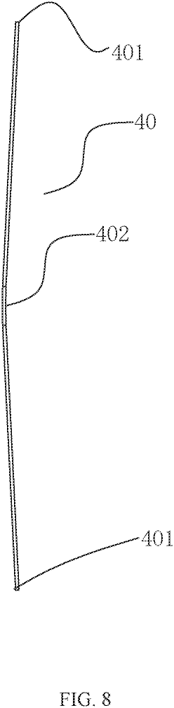

As shown in FIG. 2 and FIG. 8, the SMA wire 40 includes two opposite ends 401 and a middle movable end 402 located between the two opposite ends 401. The two opposite ends 401 are fixed to the housing 10. The two opposite ends 401 is fixed to the housing 10 in a fixing manner such as clamping, bonding and welding, which are not limited herein. In an embodiment, a metal element 70 is provided on the housing 10 at a position close to an opening 12 of the second mounting groove. The metal element 70 is configured to fix the two end positions of the SMA wire 40. The metal element 70 may clamp the SMA wire 40, so that tension force of the SMA wire 40 can be conveniently adjusted and thereby facilitating assembling or disassembling. A connection line between two fixing points where the two opposite ends 401 are fixed to the housing 10 is located in the actuation groove 51, and the middle movable end 402 is tightly suspended in the actuation groove 51. The SMA wire 40 is heated by the control system, so that the temperature of the SMA wire 40 is raised and thus the SMA wire 40 shrinks, and the middle movable end 402 gradually approaches a plane of the two opposite ends 401. In this process, a continuous actuation force is applied to the protrusion 50, such that the sensor assembly 30 moves toward the lens 20 until the focus is performed.

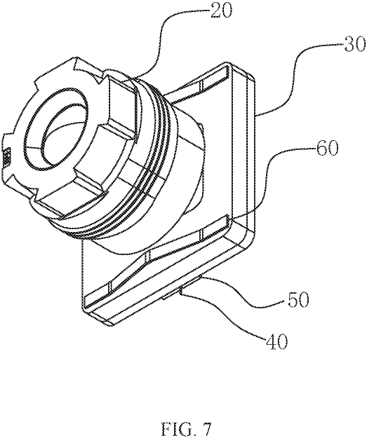

Furthermore, as shown in FIG. 7, the autofocus device further includes an elastic element. When the SMA wire 40 is cooled to expand and return to its initial length, the elastic element provides the sensor assembly 30 with a restoring force in a direction away from the lens 20, to make the sensor assembly 30 return to the initial position thereof. For example, the elastic element is a spring or an elastic sheet 60. When the SMA wire 40 is cooled to return to its initial length due to de-energizing, the elastic element can provide the sensor assembly 30 with a restoring force, which is applied in a reverse direction with respect to the actuation force generated by the shrinkage of the SMA wire 40. In this way, the sensor assembly 30 returns to the initial position, and the middle movable end 402 of the SMA wire 40 also returns to a position before the shrinkage.

Further, as shown in FIG. 7, the elastic element includes the elastic sheet 60. In some embodiments, at least two elastic sheets 60 are provided. The elastic sheets 60 are arranged symmetrically, so that the elastic restoring force is evenly distributed on the sensor assembly 30, thereby improving the restoring stability of the sensor assembly 30. The elastic sheets 60 are provided between the sensor assembly 30 and a bottom surface of the second mounting groove 12, and each of the elastic sheets 60 includes an elastic portion 601 and fixed portions 602. The fixed portions 602 are disposed at an end of the sensor assembly 30 extending into the second mounting groove 12. The elastic portion 601 is connected to the fixed portions 602 and extends toward the side away from the sensor assembly 30, and abuts against the bottom surface of the second mounting groove 12. When the sensor assembly 30 moves toward the lens 20, the elastic portion 601 of the elastic sheet 60 is compressed under a force to accumulate the elastic restoring force. When the actuation force provided by the SMA wire 40 disappears, the elastic restoring force of the elastic sheet 60 is released to provide the sensor assembly 30 with a force in a direction away from the lens 20, thereby returning the sensor assembly 30 to the initial position.

The working principle of the autofocus device according to the present disclosure is described thereinafter.

The SMA wire 40 is heated by the control system to shrink due to the heat, such that the length of the SMA wire 40 is shortened and the SMA wire 40 is straightened from a bended shape. In this way, the generated actuation force is transferred to the sensor assembly 30 through the protrusion 50 such that the sensor assembly 30 moves toward the lens 20, thereby achieving autofocusing. At this time, the elastic portion 601 of the elastic sheet 60 is compressed under a force to accumulate the elastic restoring force. When the SMA wire 40 is powered off, the temperature of the SMA wire 40 is decreased, the length of the SMA wire 40 is elongated, and the elastic restoring force of the elastic sheet 60 is released to provide the sensor assembly 30 with a force in the direction away from the lens 20, thereby returning the sensor assembly 30 to the initial position.

The structures, features, and effects of the present invention are described above in details based on the embodiments shown in the drawings. The above descriptions are merely some of the embodiments of the present disclosure, and the scope of the present disclosure will not be limited by the embodiments of the accompanying drawings. Any changes or modified equivalent embodiments with equivalent changes that are made in accordance with a concept of the present disclosure do not exceed the scope defined by the specification and drawings, shall fall within the scope of the present disclosure.

What is claimed is:

1. An autofocus device based on a movable sensor driven by an SMA wire, the autofocus device comprising:
a housing comprising a first mounting groove and a second mounting groove communicating with the first mounting groove;
a lens fixed inside the first mounting groove;
a sensor assembly provided inside the second mounting groove, the sensor assembly being reciprocally movable along a direction of an optical axis of the lens;
a driving element comprising the SMA wire wherein the SMA wire has two end portions fixed on the housing and a middle portion connected to the sensor assembly, the middle portion is further away from the lens than the two end portions, and the SMA wire is configured to drive the sensor assembly to move towards the lens under an actuation force generated by thermal shrinking of the SMA wire; and
an elastic element connected to the sensor assembly and configured to provide the sensor assembly with a restoring force in a direction away from the lens when the SMA wire is cooled to expand and return to an initial length, so that the sensor assembly returns to an initial position.

2. The autofocus device as described in claim 1, wherein the driving element further comprises a protrusion that has an end fixed to a side of the sensor assembly facing away from the lens and another end recessed to form an actuation groove;
a groove surface of the actuation groove comprises a first position end and second position ends, and the first position end is farther from the sensor assembly than each of the second position ends; and
the SMA wire is bridged in the actuation groove and attached to the groove surface of the actuation groove.

3. The autofocus device as described in claim 2, wherein the first position end is located at a middle of the groove surface of the actuation groove, and the second position ends are located at two opposite sides of the groove surface of the actuation groove.

4. The autofocus device as described in claim 3, wherein the first position end is located on an extension line of the optical axis of the lens.

5. The autofocus device as described in claim 2, wherein the SMA wire has two opposite ends and a middle movable end located between the two opposite ends, the two opposite ends of the SMA wire are fixed to the housing, and the middle movable end of the SMA wire is tightly suspended in the actuation groove.

6. The autofocus device as described in claim 5, wherein the two opposite ends of the SMA wire are fixed by clamping, bonding, or welding.

7. The autofocus device as described in claim 1, further comprising a metal element provided on the housing at a position close to an opening of the second mounting groove, and configured to fix the two end positions of the SMA wire.

8. The autofocus device as described in claim 1, wherein the elastic element comprises at least one elastic sheet provided between the sensor assembly and a bottom surface of the second mounting groove, each of the at least one elastic sheet comprises an elastic portion and a fixed portion, the fixed portion is provided at an end of the sensor assembly extending into the second mounting groove, and the elastic portion is connected to the fixed portion and extends in a direction away from the sensor assembly.

9. The autofocus device as described in claim 8, wherein the elastic element comprises at least two elastic sheets that are symmetrically arranged.

10. The autofocus device as descried in claim 1, wherein the lens is fixed inside the first mounting groove by a screw connection.
